(19) United States
(12) Patent Application Publication
(10) Pub. No.: US 2004/0205165 A1
(43) Pub. Date: Oct. 14, 2004

(54) Method for improving quality of service from an Internet server employing heuristic optimization of downloading

(75) Inventors: Shmuel Melamed, Hod Hasharon (IL); Yves Bigio, Tel Aviv (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: EPLICATION NETWORKS LTD.

(21) Appl. No.: 10/760,406

(22) Filed: Jan. 21, 2004

Related U.S. Application Data
(60) Provisional application No. 60/441,154, filed on Jan. 21, 2003.

(51) Int. Cl. G06F 15/16; G06F 17/30

(52) U.S. Cl. 709/219; 707/2

(57) ABSTRACT

A method for accelerating reception, over a network, of an object requested from a source server by an end user browser comprises using an accelerator to determine a minimal amount of content that is a fraction of the content of the object, transmitting the minimal amount of content to the end user browser and reassembling the requested object at the end-user. The minimal content includes a dynamic object with instructions and references to static components cached in the browser. The referenced static components are determined heuristically through comparisons with components of previous objects received from the same domain.

### CROSS-REFERENCE TO RELATED APPLICATIONS

This present invention claims priority from U.S. Provisional Application No. 60/441,154 filed Jan. 21, 2003, and is also related to commonly-owned PCT application WO 02/07364 A2, filed Jul. 16, 2001 (hereinafter PCT 7364).

### FIELD OF THE INVENTION

The present invention relates to the delivery of Web pages on the Internet and, more particularly, to accelerating Web page delivery by heuristic selective serving.

### BACKGROUND OF THE INVENTION

When two or more computers are connected so that they can share resources, this is referred to as a network. Two or more networks connected together are referred to as an internet (lower case i). The Internet (upper case I) is a global internet, which is a plurality of inter-connected networks, all using a common protocol known as TCP/IP (Transmission Control Protocol/Internet Protocol).

The World Wide Web (WWW, or simply Web) is a set of standards and protocols that enable the exchange of information between computers, more particularly hypertext (HTTP) servers, on the Internet, tying them together into a vast collection of interactive multimedia resources. Traffic across the Internet passes through a plurality of backbone carriers, such as UUNet or Digex, which forward the signals to one another under a system called peering.

Quality of Service (QoS) is a measure of the speed and reliability with which information can be transported from a content source (typically a server or an Internet Service Provider, ISP) to a user's computer. The computer typically runs a type of browser software, used to view content. Bandwidth is a measure of the volume of information that can be transmitted over a network (or a given portion thereof) at a given time; the higher the bandwidth, the faster the data transport. Latency is a measure of the time for a packet of data to traverse the Internet, from source to user.

The continuing exponential growth in use of the internet has led to increased congestion resulting in reduced QoS. This, in turn, engenders frustration and is an incentive to avoid using the Internet, thereby losing the great benefits thereof. Bandwidth can be increased by installing new capital resources. Increasing band-width, however, addresses latency only indirectly and cannot accelerate overloaded or slow originating servers. Moreover, increased bandwidth would quickly become congested. The cost of installing new capital resources to meet the continually growing need would be prohibitive and other solutions are required.

One solution, caching, is widely used. The principle is to store (cache) frequently accessed Web content at a location nearer the requesting client so that content has to traverse less of the Internet, thereby avoiding many bottlenecks and reducing the time to arrive at the client's browser. Caching also saves costs for users because bandwidth has to be paid for, ultimately by the end-user. The less the aggregate bandwidth used to serve a particular request, the lower the cost of serving that request.

Requests for content from a user's browser are first directed to the caching server. If the content is currently cached and is up to date, the content is sent to the client without the request having to be forwarded to the originating server. This can reduce the latency for the transfer of content and reduce the amount of time it takes to transfer the content to the user. It also reduces the amount of data the service provider has to retrieve upstream from the Internet to fulfill requests.

A Web browser has an inbuilt caching system that stores objects. An object is a response from a server to a specific URL request. An object may be a Web page itself or a Web-page component such as an HTML file, a Java script file, a style sheet file, a JPG file, etc. The objects are stored in memory for quick retrieval when the Back or Forward button of the browser is pressed.

Caching is referred to as a last-mile approach. By storing frequently accessed material closer to the end-user, it reduces delays in receiving requested material.

Another class of solutions is included under the name acceleration, which is a whole-of-trip approach. This class includes a number of approaches to QoS improvement.

Internet acceleration has little to do with the speed at which data is transferred; that is dictated by hardware and net conditions. Most Internet accelerators behave as proxy servers, a sort of middleman between a browser and the originating server, an active agent that intercepts and anticipates requests for pages and smartly manages when and/or from where a page is downloaded.

Thus a browser may make certain assumptions about what data might be requested next, download that data from an often-distant server in anticipation, store the data on a local hard drive, and serve the data therefrom when actually requested. This is called read-ahead caching and is foremost amongst techniques used to make the whole Net experience happen faster. It is aimed at giving a more satisfactory experience to an end-user, but does nothing to reduce the overall traffic on the Internet.

Read-ahead page caching can be divided into two categories; link-based and history-based.

Link-based accelerators graze indiscriminately through the Net, downloading pages that may never be requested. While a client reads the current page, all the links on it can be found and downloaded in the background. This enables instant display when a link is clicked, assuming enough loiter over the current page for background downloading to take place. Nothing has actually run faster, but future requests have been anticipated and preemptively fulfilled, giving a faster page load time onto a screen. This sort of operation can keep a modem running flat out with continual page requests. If it were used by everyone, the already congested Net would quickly hit gridlock. Moreover, such programs are not suitable for those paying for data traffic by the megabyte.

History-based acceleration works more conservatively, by downloading only pages previously visited or specified. This is like a supercharged version of the usual browser history cache, with added automatic update scheduler and cache management tools. It does not increase speed for random surfing, but previously-visited sites load more rapidly. Creatures of habit will benefit most from this sort of acceleration.

The Internet addressing protocol (IP) is numerical, so every textual URL has to be converted to a numerical equivalent by referring a request to a DNS (dynamic name server), usually a machine run by the ISP. The ISP machine matches up a URL and returns the numerical address from its database to a client machine. These processes take time. The DNS at a service provider cannot possibly hold an 1P address for every URL, so it is linked to a global network of DNSs, which can increase the lookup time. DNS caching stores the numerical IP addresses for most frequently used URLs locally, in what is called a hosts file, thus saving a call to a server.

Data compression is another way to achieve acceleration. Many Web pages can be compressed by factors typically in the range of 3:1 to 5:1; the more complex the page, the better it tends to compress. Even very sophisticated pages with code for multiple browser types compress very well. Even a modest compression can cause sufficient reduction of file transfer time to the user to be worthwhile. Not only is the page delivered and displayed sooner, but the time saving has an even greater impact because it allows the browser to get a head start on requesting the embedded resources. On many pages, this compounds the effectiveness of the savings and results in a very significant reduction in the time that a user must wait.

An existing technique automatically detects each user's connection rate, and uses the information to serve content appropriate for that rate. As the rate changes over time, the server can accurately respond thereto. By creating speed-related versions of the website content and by serving up the most appropriate version of resources at any given time, a user on a high-speed connection with little congestion between customer and website will receive the highest quality content available; if congestion reduces the effective connection rate for a period of time, a slightly reduced-quality version may be sent to ensure that the user still experiences short wait times. Similarly, for a user on a very slow link, the compression ratios are turned up to deliver content in a reasonable time, at a reasonable level of visual quality. The same technique can also be used to service more customers, at slightly reduced but adequate QoS at times of peak demand (see, for example, Internet Application Acceleration using Packeteer's AppCelera ICX, available at http://www.packeteer.com/PDF_files/appcelera/icx/icx55_paper.pdf.) These various techniques, among others, may be employed singly or in concert to provide an overall better Internet experience, but there are limits.

The more common the practice of caching becomes, the greater the need for physical caches to be deployed, with consequent capital costs. Some methods of acceleration are only sleight of hand in that there is no reduction of data sent, only a semblance of speeding up that arises from judicious pre-scheduling, often based on guesswork. Data compression does reduce the amount of data transmitted for each request by reducing duplication of transmission or tailoring the transmission to match a particular browser.

With the continuing growth of demand, it is widely recognized that some other means is needed to complement caching and existing acceleration techniques to optimize QoS on the Internet. Moreover, that means should desirably require minimal active intervention by administrators.

### SUMMARY OF THE INVENTION

According to the present invention there is provided a method for accelerating reception by a user browser of requested target original object having an original object content, the method comprising steps of: using an accelerator to determine a fractional content of the target OO that is not cached in a local browser cache, the determination including comparisons with a plurality of same domain objects; transmitting the fractional content to the user; and, at the user browser, fulfilling the request by using the fractional content and additional content received by the browser from the accelerator and from the server.

According to the present invention there is provided a method for accelerating transmission of objects between a source server and an end-user browser over a network, the method comprising steps of: providing an accelerator that communicates with the server and the end-user; receiving, by the accelerator, a target original object from the server in response to an end user request; processing, by the accelerator, the target original object to produce a reduced content dynamic object (DO) that includes reassembly instructions for reassembling the target original object and references to matching static components cached in the browser; transmitting the dynamic object to the end-user; and fulfilling the request at the end user browser by reassembling the target OO using the DO components and instructions and additional target object components missing from said local cache.

According to the present invention there is provided a method for accelerating traffic over the Internet, comprising steps of: positioning an accelerator between a source server and an end user having a browser with a browser cache, the accelerator operative to process requests from the end user and target original objects served by the server in response to user requests; processing each target OO to produce a reduced content dynamic object; transmitting the reduced content DO to the end user, and reassembling at the end user the target OO using the DO and additional required component of the target OO not stored in the browser cache.

According to the present invention there is provided a method for accelerating traffic between a server and an end-user over a network, comprising steps of: obtaining, at an accelerator interposed between the server and the end user, a request from the end-user for a target object and from the server the target object; fragmenting the target object into target dynamic and static components; identifying, in an end-user cache, static components similar to the target static components; transmitting from the accelerator to the end-user only non-similar static target components that do not have closely fitting matches in the end-user cache as well as updated dynamic components; and reassembling, at the end-user, the target object using the transmitted static components and the updated dynamic components.

According to the present invention there is provided a system for accelerating traffic over a network between a server serving a response object in response to a request from an end user comprising: a mechanism for determining fresh static and dynamic components in a most recent of the response objects served by the server, the fresh components differing substantially from previous components sent to the end-user in previous response objects and stored in an end-user cache; a mechanism for transmitting the fresh components to the end-user; and a mechanism for reassembling the most recent response object at the end-user using the transmitted fresh components.

### BRIEF DESCRIPTION OF THE DRAWINGS

Reference will be made in detail to preferred embodiments of the invention, examples of which may be illustrated in the accompanying figures. The figures are intended to be illustrative, not limiting. Although the invention is generally described in the context of these preferred embodiments, it should be understood that it is not intended to limit the spirit and scope of the invention to these particular embodiments.

The structure, operation, and advantages of the invention will become further apparent upon consideration of the following description, taken in conjunction with the accompanying figures, wherein:

FIG. 1 is a representation of a typical Web page showing static and dynamic embedded objects;

FIG. 2 shows an associated Web page having common embedded static objects;

FIG. 3 shows a flow chart of the acceleration process;

FIG. 4 shows schematically the various elements of the system performing the method of the present invention

### DETAILED DESCRIPTION OF THE PREFERRED EMBODIMENTS

The present invention relates to methods for improving quality of service from an Internet server by employing heuristic optimization of downloading. The invention discloses a method for accelerating transmission over a network of objects to, and reception of objects by an end-user. The objects are transmitted upon a user request to a server. The method is applicable to objects originating from a domain. A particular example of a domain is a Website that includes a large number of objects (pages). The method involves a whole-of-trip approach, achieving acceleration by transmitting to the user browser a fraction of the components of a requested page, plus references to objects cached in a local cache at the browser and reassembly instructions. In contrast with various known compression methods, which compress a single object (page) before transmission to the user, the present invention performs compression based on a plurality of objects from the same domain. That is, in the present invention, the transmitted “fractional” content is determined by a comparison between the requested object and content (components) of a set of previous objects obtained from that domain. The process is a continuous one, in which the “databases” of previous objects and components used for comparison are constantly updated. The accelerator is positioned on the server side, preferably in the proximity to the server.

A preferred embodiment of the present invention applies to a Website (domain) containing a plurality of objects. The following discussion will focus on a Web page (HTML file) as a particular example of an object. This is not to restrict the breadth of the present invention but for the purpose of discussion. The concepts and processes described hereunder may be applied to other objects as appropriate.

What an end-user sees as a Web page is an on-screen representation of encoded instructions. In general, the instructions will have been written to correspond to a mixture of pictorial, textual, and aural data to be displayed on a computer screen and/or through speakers, and so on. The instructions will include some to fetch data for display and others as to how to display that data. There may also be included information regarding the TTL or shelf life of particular data elements, so that the end-user's browser will know whether to fetch fresh data when, for example, a page stored in the browser cache is recalled therefrom. In the coding there will be a greater or lesser degree of duplication. This also applies between related pages at the same Website.

The present invention achieves optimized transmission by breaking up (fragmenting) an original object requested by a user, e.g. an index.HTML page (which can be a dynamic object that cannot be cached) into dynamic content (components) and static components (which can be objects themselves). Static components (static embedded objects) include “fixed” or long-term unchanging components, zones or parts of Web pages stored as files that are either never changed or changed only on an infrequent basis. The dynamic component (content) is “live” content that is updated on a regular basis, such as a “current temperature” display for weather, search results, a “current news headlines” item, etc. Only static components that do not already exist in a local cache at the end-user browser are then transmitted, together with any required dynamic content updates.

The static components are referred to herein also as “embedded static objects”. The embedded static objects from this original object can be used on other pages from the same domain. Each static object may be further subdivided into sections or “sub-objects”. The method uses some static objects repeatedly to fulfill future requests, and these are called accordingly reusable application objects (RAOs).

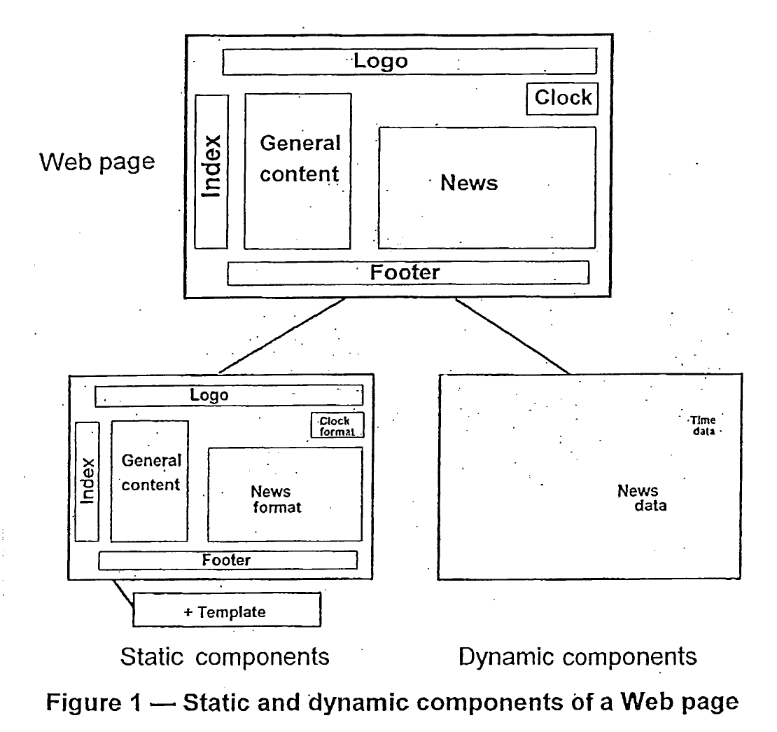

FIG. 1 shows a typical Web page and some static and dynamic components thereof. In this example, the embedded static objects include a logo, some general content and a footer. As mentioned, these static components are respectively invariant over relatively long periods of time. Other static components include a page background (not shown) and component borders, the invariant parts of the clock and, less obviously, formatting and style instructions such as table structure and page styling, which are themselves invisible but whose effects are seen. The dynamic content includes time data for the clock, which constantly changes, and news data, which is updated from time to time, with variable frequency.

It is clear that the terms ‘static’ and ‘dynamic’ are not absolute so that what is included in each category may differ depending upon circumstances and requirements.

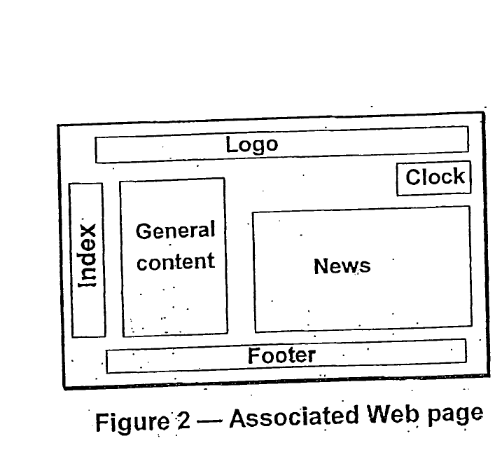

FIG. 2 shows a Web page associated with the Web page of FIG. 1. In general, this will be another page at the same Website. An associated page will usually include embedded static objects common with the original page such as, in this example, the logo, footer, clock, index and background, and will normally have a similar URL, at least at the higher-level parts of the URL.

In general, as mentioned, a Website contains a plurality of Web pages A, B, C, D, . . . each containing a plurality of components selected from a set including: α, β, γ, δ, . . . Components may be static or dynamic and different components may appear in different pages. The particular assemblage of components in any particular page may vary with time.

In the present invention, the accelerator fragments each Web page at a particular Website into static and dynamic components, assigning each component its own reference. A server may receive many requests. The accelerator compiles a dynamic history of such requests and, based on this dynamic history, determines the common components of the requests. Common components may include: styles, tabular layouts, java script, logo, background, parts of these objects, etc. The accelerator then “rebuilds” the Website by combining the common components in different pages of the requests into a few new Web pages.

Moreover, by performing statistical analyses of the requests and the pages requested, the accelerator can classify the components in those pages as static and dynamic. This is done on a continual basis, according to updated analyses. The statistical analysis preferably uses the algorithms of PCT 7364.

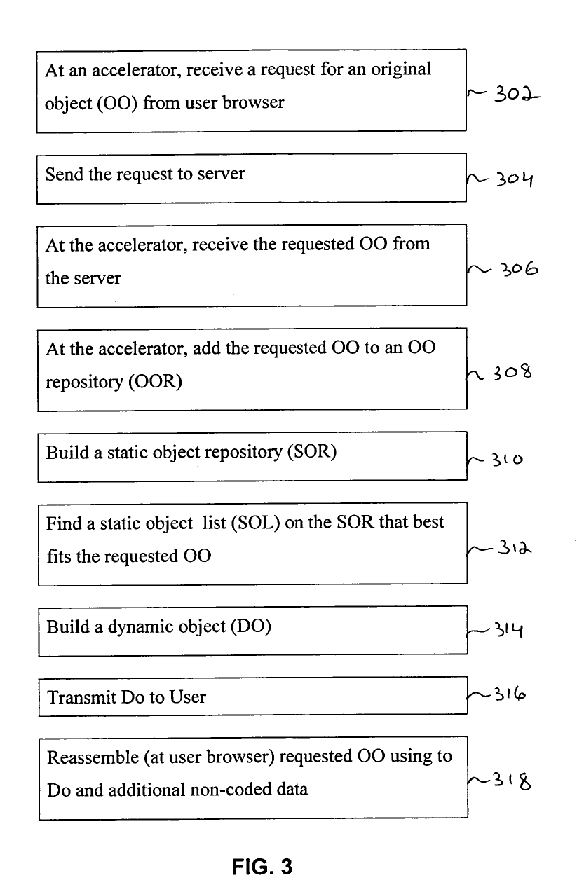

The acceleration method is described schematically in the flow chart of FIG. 3 and includes the steps of: at the accelerator:

Receiving a request from a user browser in step 302;

Sending the request to an originating server in step 304;

Receiving an original object OO (e.g. “target” Web page) from the server in step 306;

Adding the OO to an original object repository (OOR) in step 308;

Building, preferably periodically, a static object (SO) repository (SOR) by analyzing and comparing all the objects in the OOR in step 310. Each entry in OOR repository contains a pointer to OO attributes, i.e. the request URL and a list of pointers to a SO “score-of-match level”.

Finding a static objects list (SOL) in the SOR that can fit best (percentage wise) the OO in step 312. The fit is provided by preferably using an algorithm that employs the requested URL as a hint, by running a comparison between the OO and each of the SOs from the SOL, as described in more detail below. When a new OO is received, the corresponding URL is searched in the SOR URL for the best matching URL (similarity matching) and for the highest score in the match level entry. When these are found, the matching SO is appended into the SOL.

Building a dynamic object (DO) or “container” that will be sent to the user as a reply to his request, i.e. building a new HTML (DO) in step 314. The DO includes:

references to every SO in the SOL;

a reference to a browser rendering object (BRO) i.e. a Java script that is used on the browser's side to assemble and rebuild a page that resembles the OO, and

a dynamic data array that consists of (a) unmatched areas between the OO and any SO from the SOL, and (b) pointers to a location inside the SO that is matched within the OO. Specifically the dynamic data array includes:

a reference to a location inside each SO;

a substring offset (the starting point of a string to be extracted from the SO and inserted into the target page); and

the length of the string to be extracted from the SO.

Finally, the accelerator sends the DO to the user in step 316.

For example, assume that a Website includes pages A, B, C, etc:

pageA.HTML=containerA.HTML,

pageB.HTML=containerB.HTML,

pageC.HTML=containerB.HTML, etc . . .

The reconstructed container (DO) X.HTML (where X stands for A, B, C, etc) pages will contain pointers to relevant static and dynamic content, as determined by the accelerator:

| | |
|---|---|
| containerA.HTML = | common-static.HTML |
| | common-dynamic.HTML |
| | staticA.HTML |
| | dynamicA.HTML |
| containerB.HTML = | common-static.HTML |
| | common-dynamic.HTML |
| | staticB.HTML |
| | dynamicB.HTML |
| containerC.HTML = | common-static.HTML |
| | common-dynamic.HTML |
| | staticC.HTML |
| | dynamicC.HTML |

etc. In this way, a request to update a page or to serve another page from the same website can be served so that only required material is sent, the rest being fulfilled by material already in the user browser, resulting in a reduction of material being transmitted over the Web. That is to say, a particular request is served by sending only the differences between the request and all earlier requests, that is, only objects that do not already exist in the requesting browser cache.

On the user side, the browser receives the DO and tries to locate the objects referred to in the DO (SOs, BRO, JPG files, etc) in its local cache. If some of these objects are not located in the cache, the browser retrieves them from the server. The browser then handles the assembly of the page by running the BRO script (see details below) in step 318. Note that an existing standard browser (e.g. Microsoft Explorer or Netscape Navigator) does not need any additional code, plug-ins or thin clients to handle the reassembly.

The invention can also analyze the minimal required amount of information to fulfill a request according to common and individual requests. For example, a popular search engine always presents its search questionnaire page(s) identically to all clients. The results page(s) will differ markedly, according to the information sought. The results page(s), however, are not really as different as they seem, because they contain large amounts of identical coding relating to format, styling, etc. Only the data relating to the particular request differs, and this is often a small fraction of the total page, so the scope for saving bandwidth is evident.

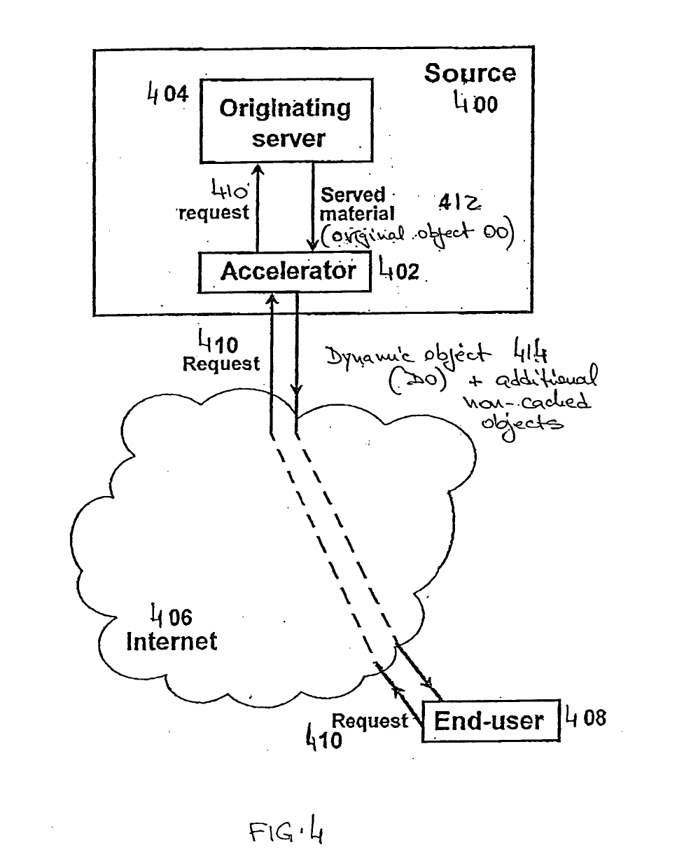

The application of the present invention may be better understood with reference to FIG. 4. A request 410 for a URL representing a Web page originates from an end-user 408 and is transmitted via an Internet 406 to a server 404 at a source 400 for fulfillment. At source 400, request 410 is intercepted by an accelerator 402. The accelerator received a requested (target) original object 412 and performs the fragmentation into static and dynamic components and the determination of which static components and dynamic updates need to be sent to the user. The accelerator then replies to the end user request with an object (DO) 414 that includes references and instructions as described with reference to FIG. 3. As mentioned above, the reply DO “container” includes dynamic data, reassembly instructions (script) and references to static objects that can be obtained from browser cache and used in the reassembly process. In other words, the DO describes what objects are needed to fulfill the original request. If an object URL already exists (i.e. the object is a static object or one that does not require updating) that object will not need to be down-loaded from the server.

The browser of end-user 408 then executes the script, which parses the information page and requests a URL object download for any object that does not already exist in the browser cache (or any object that requires updating). Any object referred to in the DO and not found in the local cache is then received from the server (or in the case of static objects from the accelerator). On fulfillment of these requests, the browser builds the required object according to the instructions in the DO, using local cached components and the additional served components, and writes the required object to the screen.

In the case of URL analysis, a requested object (e.g. Web page) is compared with a number of previously served Web pages according to similarity of the URLs. A required degree of similarity can be preset, as can a search depth. Similar provisions can be preset for matching according to HTTP data. The basic assumption here is that URLs can be used to detect the likeness of related Web pages. If U_{X} is the URL of page X, and if U_{A} matches U_{B} better than U_{A} matches U_{C}, then it is assumed that page A will match page B more closely than page C. The practical application in acceleration according to the present invention is that a difference from a closer matching page should be transmitted in preference to a difference from a less closely matching page.

The “closeness of match” or the “fit” may change dynamically, so accelerator 402 compiles a mapping of the closeness of match that may be applied when deciding which differences are to be served in response to a request. For example, at a website including the following pages (denoted also by reference ID numbers):

| URL | Ref ID |
|---|---|
| http://www.foo.com/art/group12.asp | r9221 |
| http://www.foo.com/installation/productlist.asp | r1253 |
| http://www.foo.com/news/article108.asp | r2002 |
| http://www.foo.com/news/article112.asp | r7321 |
| http://www.foo.com/news/topic301.asp | r4558 |

| Ref Id | SO | Score | SO | Score | . . . | . . . |
|---|---|---|---|---|---|---|
| r9221 | So1 | 89 | So2 | 98 | | |
| r1253 | So2 | 78 | So5 | 89 | | |
| r7321 | So3 | 89 | So2 | 96 | | |

a request for a page with URL: http://www.foo.com/news/article110.asp would be regarded as matching the following pages in descending order of closeness: r7321, r2002, and r4558 (for a search depth=3). Depending upon which of these pages had already been served, accelerator 402 would send only the difference between the SOs of those pages and the newly requested (“target”) original object or page (OO), as well as a pointer to the SOs (as defined before for the DO) of the previous pages. In practice, previously served pages may have been transmitted as SO pages plus a patch (dynamic objects, i.e. the differences between the SO pages and the OO page), whereupon the new request could be served as a selected SO pages and the difference from the requested OO thereof. This provides a fast search based on URL similarity. By these methods, the amount of material to be served to fulfill any particular request may be greatly reduced, thereby speeding significantly the fulfillment of a request at end-user 408.

The determination by accelerator 402 of whether a component is stale or fresh and thus does or does not need to be re-served is preferably done according to an algorithm described in PCT 7364. This algorithm involves statistical analysis of requests for and updates of objects A, B, C, D, etc and components α, β, γ, δ, etc to determine average request rates, average update frequencies, average error rates, and average delay times. Accelerator 402 is pre-supplied with algorithms described in PCT 7364 to determine these averages and to make required comparisons and decisions that follow therefrom. Accordingly, accelerator 402 may be installed and run transparently, normally without external intervention.

Analyzing pages for association can also be applied to detecting pages that are entirely or almost entirely unrelated to other pages on a website. This is useful as a security measure, by detecting pages that most probably do not belong. Analyzing incoming requests to determine whether existing classes of URLs at a website match might lead to rejection of an incoming request as improper or as some sort of unwelcome intrusion.

To summarize, the accelerator sends to a requesting browser only those dynamic components that need refreshing, as well as references to the static components already held in the client browser cache, whether from an earlier request for the page or from a request for an associated page. Because the process of analysis goes on continuously, the accelerator can educate itself as to usage patterns and redefine the fragmentation process heuristically.

It is important to emphasize that the “compression” (i.e. the transmission of less than the entire data in an object) as disclosed herein is essentially different from normal compression as practiced in prior art. In contrast with normal compression, the present method (using an accelerator) separates static and dynamic components (objects) of a requested object, and sends to the end user only those static components and dynamic updates that do not exist, even approximately, in a cache or memory proximal to the user. More importantly and uniquely, this determination uses a plurality of objects from the same domain to form a constantly changing SOL. The accelerator “knows” what the end-user cached static components are, from a continuous or periodic check that refers to and involves a plurality of previous objects served to the end user from the same domain. This check provides a “fit” of cached objects to objects in the most recent request, removing the need to serve these objects, thereby accelerating the transmission of the requested object. In essence, the present compression uses a plurality of same-domain pages, in contrast with normal compression, which is applied always to a single page.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made. It will be obvious to anyone with an ordinary knowledge of the art that the method of the present invention may be used in conjunction with network caching and with other acceleration techniques to achieve even greater acceleration than achieved solely by the method disclosed herein.

What is claimed is:

1. A method for accelerating reception by a user browser of a target original object (OO) having an original object content, the OO transmitted from a originating server over a network in response to a request by the user, the method comprising steps of:
a. using an accelerator to determine a fractional content of the target OO that is not cached in a local browser cache, said determination including comparisons with a plurality of same domain objects
b. transmitting said fractional content to the user, and
c. at the user browser, fulfilling the request by using said fractional content and additional content received by the browser from said accelerator and from the server.

2. The method of claim 1, wherein said step of using an accelerator to determine a fractional content includes
i. building a static object repository (SOR) that includes static objects (SOs),
ii. finding a static object list (SOL) in said SOR that best fits the target OO, and
iii. building a dynamic object (DO) that includes reference to each static object in said SOL as well as additional information, said dynamic object characterized by having less content than said target OO content,
and wherein said step of transmitting includes transmitting said dynamic object to the user.

3. The method of claim 2, wherein said building a SOR is preceded by preparing an original object repository (OOR), wherein said building a SOR is performed by analyzing and comparing all OOs in said OOR, and wherein said finding a SOL that best fits the target OO includes running a comparison between the target OO and each of the SOs in the SOL using a URL of the target OO as a hint.

4. The method of claim 2, wherein said additional information in said DO includes:
a reference to a browser rendering object (BRO) having a BRO script that includes a substring offset, a length of the string to be extracted from the target OO and an offset, and
ii. a dynamic data array that consists of an unmatched areas between the target OO and any SO from said SOL, and pointers to a location inside each said SO that is matched within the target OO.

5. The method of claim 4, wherein said dynamic data array further includes:
A. a refernce to each said SO in said SOL,
B. a substring offset (the starting point of a string to be extracted from said SO and inserted into the target OO);
C. the length of the string to be extracted from said SO; and
D. an offset (i.e. placement location) in the container page.

6. The method of claim 1, wherein each said original object is a Web page.

7. A method for accelerating transmission of objects between a source server having a domain and an end-user browser over a network, the method comprising steps of:
a. providing an accelerator that communicates with the server and the end-user,
b. receiving, by said accelerator, a target original object (OO) from the server in response to an end user request,
c. processing, by said accelerator, said target OO to produce a reduced content dynamic object (DO) that includes references to matching static objects (SOs) stored in a local cache of said browser, dynamic objects that need refreshing, and reassembly instructions for reassembling said target OO,
d. transmitting said DO to the end-user, and
e. fulfilling said request at the end user browser by reassembling said target OO using said DO references, objects and reassembly instructions and additional target object components missing from said local cache.

8. The method of claim 7, wherein said step of processing of said target OO includes identifying a static object list (SOL) that may fit said target OO, and wherein said step of transmitting includes transmitting references to SOs in said SOL instead of transmitting said SOs to the end-user, thereby reducing the amount of traffic between the source server and the end user.

9. The method of claim 8, wherein said identifying of a static object list (SOL) that may fit said target OO is preceded by building, using previous OOs requested from the domain, an original object repository (OOR) in which each entry contains a pointer to OO attributes such as a request URL and a list of pointers to a SO score-of-match level, and wherein said identifying further includes building, preferably periodically, a static object repository (SOR) by analyzing and comparing all the objects in said OOR, said SOR used to form said SOL.

10. A method for accelerating traffic over the Internet, comprising steps of:
a. positioning an accelerator between a source server and an end user having a browser with a browser cache, said accelerator operative to process requests from the end user and target original objects (OO) served by the server in response to user requests,
b. processing each said target OO to produce a dynamic object (DO),
c. transmitting said DO to the end user, and
d. reassembling at the end user the target OO using said DO and additional required data not stored in said cache.

11. The method of claim 10, wherein said step of processing includes fragmenting each said target OO into dynamic and static components and determining which of said static components do not already exist in said browser cache and which of said dynamic components need refreshing, and wherein said step of transmitting includes transmitting with said DO only said static components or parts that do not already exist in said browser cache and said dynamic components that need refreshing.

12. The method of claim 11, wherein said determining is done heuristically, based on a plurality of OOs previously received by said accelerator from the same domain in the Internet.

13. The method of claim 11, wherein said fragmenting is done heuristically.

14. The method of claim 11, wherein said target OO is a Web page.

15. A method for accelerating traffic between a server and an end-user over a network, comprising steps of:
a. obtaining, at an accelerator interposed between the server and the end user, a request from the end-user for a target object and from the server said target object
b. fragmenting said target object into target dynamic and static components,
c. identifying, in an end-user cache, static components similar to said target static components,
d. transmitting to the end-user only non-similar target static components that do not have closely fitting matches in said end-user cache as well as updated dynamic components, and
e. reassembling, at the end-user, said target object using said transmitted static components and said updated dynamic components.

16. The method of claim 15, wherein said network is the Internet and wherein said target object is a Web page.

17. A system for accelerating traffic over a network between a server serving a response object in response to a request from an end-user comprising:
a. a mechanism for determining fresh static and dynamic components in a most recent of the response objects served by the server, said fresh components differing substantially from previous components sent to the end-user in previous response objects and stored in an end-user cache,
b. a mechanism for transmitting said fresh components to the end-user, and
c. a mechanism for reassembling said most recent response object at the end-user using said transmitted fresh components and required components of said recent response object not cached in said cache.

18. The system of claim 17, wherein said mechanism for determining fresh static and dynamic components in a most recent of the response objects served by the server includes an accelerator operative to fragment a requested object into static and dynamic components and perform a comparison between said static components and said end-user cached components to identify said fresh components, and wherein said mechanism for transmitting said fresh components to the end-user includes a dynamic object having including said fresh components, reference to fitting said previous components and reassembly instructions.
